(19) United States
(12) Patent Application Publication
(10) Pub. No.: US 2025/0273819 A1
(43) Pub. Date: Aug. 28, 2025

(54) POWER STORAGE APPARATUS AND BATTERY PACK STRUCTURE

(71) Applicant: TOYOTA JIDOSHA KABUSHIKI KAISHA, Toyota-shi Aichi-ken (JP)

(72) Inventor: Isamu HAYAKAWA, Okazaki-shi Aichi-ken (JP)

(73) Assignee: TOYOTA JIDOSHA KABUSHIKI KAISHA, Toyota-shi Aichi-ken (JP)

(21) Appl. No.: 19/049,027

(22) Filed: Feb. 10, 2025

(30) Foreign Application Priority Data
Feb. 22, 2024 (JP) 2024-025746

(51) Int. Cl. H01M 50/474; H01M 4/02; H01M 10/48; H01M 50/204; H01M 50/477; H01M 50/486

(52) U.S. Cl. CPC H01M 50/474; H01M 4/02; H01M 10/482; H01M 50/204; H01M 50/477; H01M 50/486; H01M 2004/029

(57) ABSTRACT

A power storage apparatus includes: a plurality of stacked metal plates; and a sealing body for sealing an interior space formed between two adjacent metal plates of the plurality of the metal plates, in which the plurality of the metal plates include a first metal plate which is a positive terminal electrode, a second metal plate which is a negative terminal electrode, and a plurality of third metal plates which are a plurality of bipolar electrodes provided between the first metal plate and the second metal plate, each of the plurality of the bipolar electrodes includes a voltage detection terminal, each of the plurality of the third metal plates includes a positive electrode formed on one surface of the third metal plate and a negative electrode formed on the other surface of the third metal plate, and a support member is provided in the interior space.

### CROSS REFERENCE TO RELATED APPLICATIONS

This application is based upon and claims the benefit of priority from Japanese patent application No. 2024-025746, filed on Feb. 22, 2024, the disclosure of which is incorporated herein in its entirety by reference.

### BACKGROUND

The present disclosure relates to a power storage apparatus and a battery pack structure.

Patent Literature 1 discloses a power storage module in which a plurality of bipolar electrodes are stacked.
Patent Literature 1: Japanese Unexamined Patent Application Publication No. 2021-174632

### SUMMARY

A bipolar electrode has a structure in which a positive electrode is formed on one side of a metal plate (a current collector) and a negative electrode is formed on the other side of the metal plate. A positive electrode and a negative electrode can be easily formed by coating a metal plate with an active material.

On the other hand, in the case where a metal plate has a region that is not coated (a non-coated part), buckling due to the own weight of the metal plate may occur in the non-coated part when a plurality of bipolar electrodes are stacked. In addition, in the case where a thermal stress is repeatedly applied to the power storage module due to temperature change, fracture may occur in the buckled metal plate.

The present disclosure has been made in order to solve the aforementioned problems, and it is an object of the present disclosure to provide a power storage apparatus and a battery pack structure that are resistant to a bending stress.

According to the present disclosure, a power storage apparatus includes: a plurality of stacked metal plates; and a sealing body for sealing an interior space formed between two adjacent metal plates of the plurality of the metal plates, in which the plurality of the metal plates include a first metal plate which is a positive terminal electrode, a second metal plate which is a negative terminal electrode, and a plurality of third metal plates which are a plurality of bipolar electrodes provided between the first metal plate and the second metal plate, each of the plurality of the bipolar electrodes includes a voltage detection terminal, each of the plurality of the third metal plates includes a positive electrode formed on one surface of the third metal plate and a negative electrode formed on the other surface of the third metal plate, and a support member is provided in the interior space. With this configuration, it is possible to provide a power storage apparatus resistant to a bending stress.

Further the support member may be an insulating flat plate having durability against a bending stress. With this configuration, it is possible to suppress buckling of the power storage apparatus.

Further, the support member may be an insulating dot print or a resin rectangular timber provided at the center of the interior space. With this configuration, it is possible to suppress buckling of the power storage apparatus.

Further, the support member is formed in a region of the third metal plate where the positive electrode and the negative electrode are not formed. With this configuration, it is possible to suppress buckling of the power storage apparatus.

Furthermore, a battery pack structure according to the present disclosure is formed by stacking a plurality of the power storage apparatuses. With this configuration, it is possible to provide a battery pack structure that is resistant to a bending stress.

According to the present disclosure, it is possible to provide a power storage apparatus and a battery pack structure that are resistant to a bending stress.

The above and other objects, features and advantages of the present disclosure will become more fully understood from the detailed description given hereinbelow and the accompanying drawings.

### BRIEF DESCRIPTION OF DRAWINGS

FIG. 1A is a diagram illustrating a power storage apparatus according to the present disclosure;

FIG. 1B is a diagram illustrating a power storage apparatus according to the present disclosure;

FIG. 2A is a diagram illustrating a support member of a power storage apparatus according to the present disclosure;

FIG. 2B is a diagram illustrating a support member of a power storage apparatus according to the present disclosure;

FIG. 3A is a diagram illustrating a related power storage apparatus;

FIG. 3B is a diagram illustrating a related power storage apparatus;

FIG. 4A is a diagram illustrating buckling and fracture occurring in a molding apparatus; and

FIG. 4B is a diagram illustrating buckling and fracture occurring in a molding apparatus.

### DESCRIPTION OF EMBODIMENTS

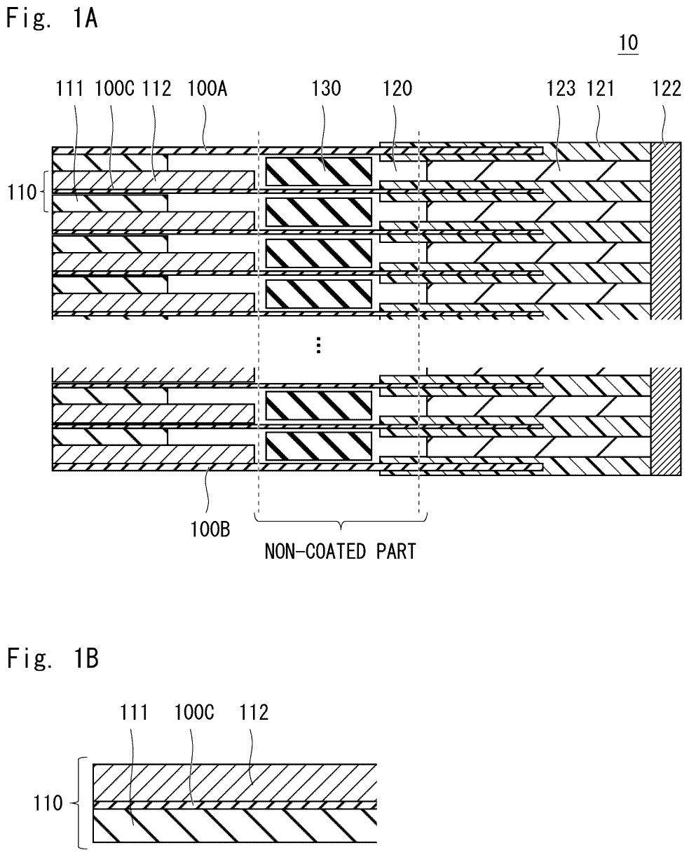

Hereinafter, embodiments of the present disclosure will be described with reference to the drawings. FIG. 1A is a diagram illustrating a power storage apparatus 10 according to the present embodiment.

The power storage apparatus 10 includes a stacked body having a plurality of stacked metal plates 100. The plurality of the metal plates 100 are classified into a first metal plate 100A which is a positive electrode terminal, a second metal plate 100B which is a negative terminal electrode, and a plurality of third metal plates 100C constituting a plurality of bipolar electrodes 110 provided between the first metal plate and the second metal plate. In some embodiments, the metal plates are formed of Al, Cu, or the like. A battery pack structure is obtained by stacking a plurality of power storage apparatuses 10.

In the configuration example shown in FIG. 1A, the stacked body is provided with the first metal plate 100A, which is a positive terminal electrode, on an upper surface in the stacking direction, and the second metal plate 100B, which is a negative terminal electrode, on a lower surface in the stacking direction. However, the configuration of the stacked body is not limited to that shown in FIG. 1A, and as regard the positional relationship of a positive electrode and a negative electrode in the stacking direction, a location of a positive terminal electrode and a location of a negative terminal electrode may be interchanged in the configuration shown FIG. 1A.

FIG. 1B illustrates an enlarged view of the bipolar electrode 110. Each of the plurality of the bipolar electrodes 110 includes the third metal plate 100C, a positive electrode 111 formed on one surface of the third metal plate 100C, and a negative electrode 112 formed on the other surface of the third metal plate. The positive electrode 111 is formed by coating one surface of the third metal plate 100C with a positive electrode active material, and the negative electrode 112 is formed by coating the other surface of the third metal plate with a negative electrode active material.

In some embodiments, a voltage detection terminal (not shown) is provided in a region (non-coated part) of the bipolar electrodes 110 where the positive electrode 111 and the negative electrode 112 are not formed. This facilitates quality control.

An interior space 120 is formed between two adjacent metal plates of the plurality of the metal plates 100. As an example, FIG. 1A shows the interior space 120 formed between the first metal plate 100A and the third metal plate 100C adjacent to the first metal plate 100A.

The power storage apparatus 10 according to the present disclosure includes sealing bodies 121 and 122 for sealing the interior space 120 and a spacer 123 for maintaining the thickness of the stacked body. In some embodiments, the sealing bodies 121 and 122 have chemical resistance against an electrolyte (not shown) to be filled in the interior space 120, and a resin material such as polypropylene is used, for example.

The power storage apparatus 10 according to the present disclosure includes a support member 130 in the interior space 120. In some embodiments, the support member 130 is provided in a region (a non-coated part) of the third metal plate 100C where the positive electrode 111 and the negative electrode 112 are not formed.

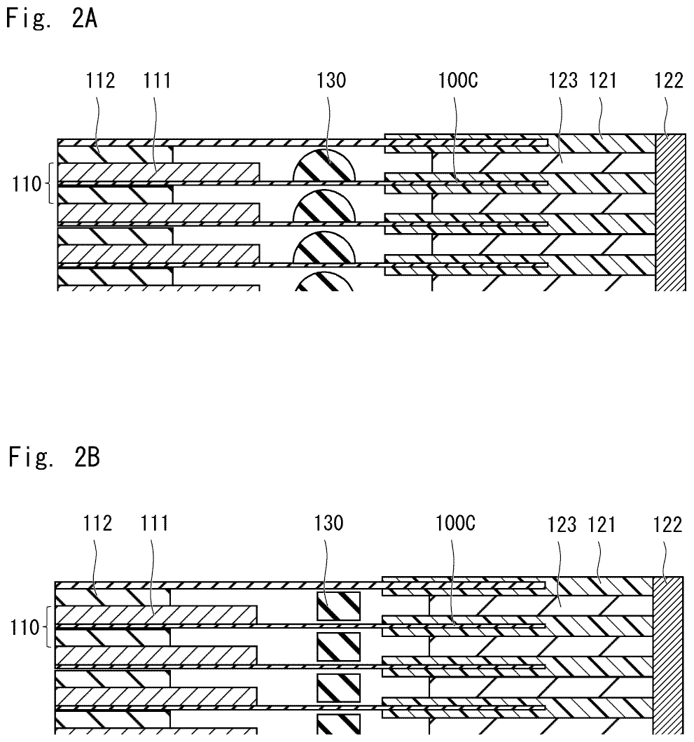

In some embodiments, the support member 130 is an insulating flat plate having durability against a bending stress. As shown in FIGS. 2A and 2B, as the support member 130, a dot print (see FIG. 2A) or a resin rectangular timber (see FIG. 2B) may be provided at the center of the interior space 120. In some embodiments, the dot print and the resin rectangular timber have insulating properties.

With such a configuration, buckling of the third metal plate 100C due to its own weight can be prevented, thereby providing a power storage apparatus that is resistant to a bending stress.

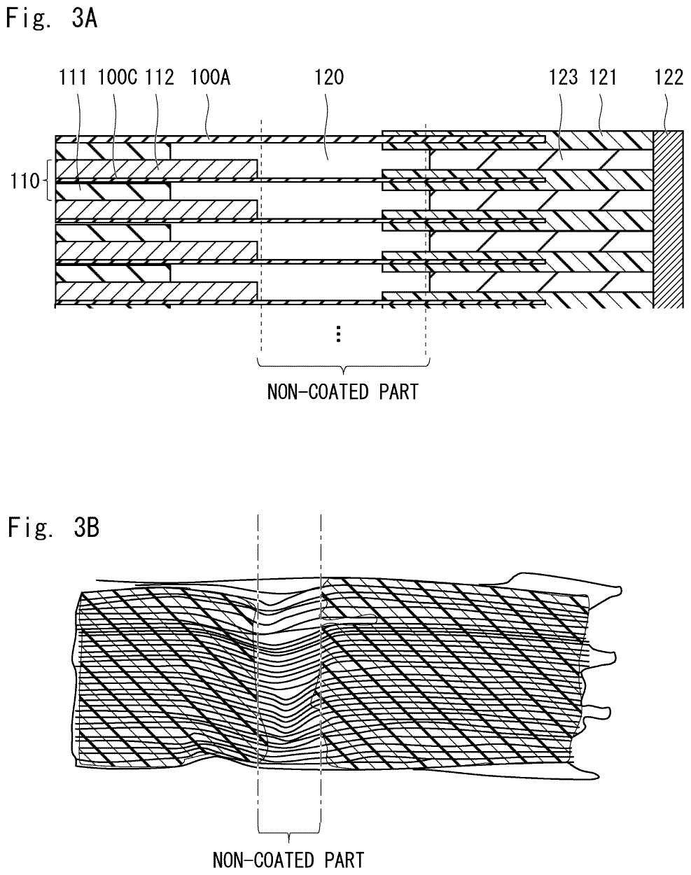

As a comparative example, FIG. 3A shows a configuration of a power storage apparatus in which the support member 130 is not provided. In the third metal plate 100C of the bipolar electrodes 110, a buckling may occur in a region (non-coated part) where the positive electrode 111 and the negative electrode 112 are not formed, thereby causing fracture in the metal plate (see FIG. 3B).

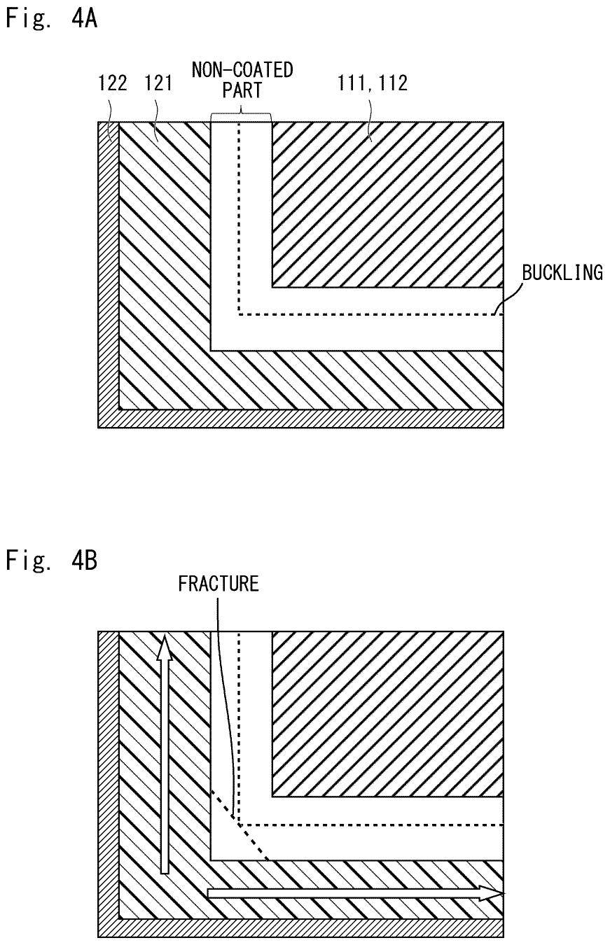

The mechanism of buckling and fracture will be described with reference to FIGS. 4A and 4B. FIGS. 4A and 4B show a plan view of the power storage apparatus shown in FIG. 3A in which illustration of the first metal plate 100A is omitted and the corner portion is enlarged. The moment of inertia of area of the region (the non-coated part) of the third metal plate 100C where the positive electrode 111 and the negative electrode 112 are not formed is small. In addition, since the non-coated part extends in the longitudinal direction and the transverse direction in the plan view, buckling easily occurs in this region due to the own weight of the metal plate (see FIG. 4A).

Since the sealing bodies 121 and 122 are made of a resin material, they easily expand and contract due to a change in the temperature of the power storage apparatus. For example, in the case where the temperature of the power storage apparatus in which buckling has occurred is set at a low temperature, a stress acts in the direction of the arrow shown in FIG. 4B, and a fracture occurs due to buckling and shrinkage of the resin material.

In the power storage apparatus 10 according to the present disclosure, by providing an insulating flat plate having durability against a bending stress to the non-coated part, buckling due to the own weight of the metal plate can be prevented. In the power storage apparatus 10 according to the present disclosure, by providing an insulating dot print or a resin rectangular timber to the non-coated part, the moment of inertia of area of the metal plate can be compensated, and buckling due to the own weight of metal plate can be prevented.

In this way, a power storage apparatus and a battery pack structure that are resistant to a bending stress can be provided.

It should be noted that the present disclosure is not limited to the above embodiments, and may be appropriately modified without departing from the purpose.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A power storage apparatus comprising:
a plurality of stacked metal plates; and
a sealing body for sealing an interior space formed between two adjacent metal plates of the plurality of the metal plates, wherein
the plurality of the metal plates include a first metal plate which is a positive terminal electrode, a second metal plate which is a negative terminal electrode, and a plurality of third metal plates which are a plurality of bipolar electrodes provided between the first metal plate and the second metal plate,
each of the plurality of the bipolar electrodes includes a voltage detection terminal,
each of the plurality of the third metal plates includes a positive electrode formed on one surface of the third metal plate and a negative electrode formed on the other surface of the third metal plate, and
a support member is provided in the interior space.

2. The power storage apparatus according to claim 1, wherein the support member is an insulating flat plate having durability against a bending stress.

3. The power storage apparatus according to claim 1, wherein the support member is an insulating dot print or a resin rectangular timber provided at a center of the interior space.

4. The power storage apparatus according to claim 1, wherein the support member is formed in a region of the third metal plate where the positive electrode and the negative electrode are not formed.

5. A battery pack structure formed by stacking a plurality of the power storage apparatuses according to claim 1.
